(19) United States
(12) Patent Application Publication
(10) Pub. No.: US 2006/0155836 A1
(43) Pub. Date: Jul. 13, 2006

(54) Method of configuring network device

(75) Inventors: Tzu-Houg Chang, Hsinchu City (TW); Yuan-Te Hsieh, Hsinchu City (TW); Chien-Min Tai, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Arcadyan Technology Corporation

(21) Appl. No.: 11/026,176

(22) Filed: Dec. 30, 2004

(51) Int. Cl. G06F 15/173

(52) U.S. Cl. 709/223

(57) ABSTRACT

A method of configuring a network device based on an easy configuration protocol. The method includes: sending a discovery packet to discover the network device, wherein the discovery packet includes a port number, and a destination address for broadcasting; then, receiving a response packet if the network device recognizes the discovery packet and if the port number of the network device is the same as indicated by the discovery packet; sending a query packet to query management information; and sending a setting packet having a plurality of attributes to set the network device.

### BACKGROUND OF THE INVENTION

1. Field of the Invention

The invention relates in general to a method of communication, and more particularly to a method of configuring a network device.

2. Description of the Related Art

To configure a network device in order to establish and manage file transfer and resources sharing on a small network or a communications system, the network devices must rely on the same communication protocol, and examples of conventional protocols are such as SNMP (Simple Network Management Protocol) and UPnP (Universal Plug and Play).

For the network or communications system that relies on the SNMP for configuration, the network device itself must be pre-installed of the SNMP protocol. The network device is such an access point (AP), an ethernet converter (EC), a residential gateway (RG) or others that provide network services to client devices in the network system. An example of a client device is such as a personal computer with a LAN card. Before starting to provide network services, the network device should be configured by the client device to cooperate in the network system and the configured attributes are such as IP address, domain name, and etc. In addition to the SNMP protocol, users also have to ensure that the network device and the client device are both under the same internet protocol (IP) subnet in order to enable access for configuration.

Given such constraints, users feel the most inconvenient when having to initialize settings for more than one network device on the network, which involves the configuration of many attributes. To make configuration settings, users not only have to go through the burden of ensuring whether network devices are SNMP ready, but are also obligated to make certain that all network devices are in the same IP subnet. Hence, while the SNMP may be the standard in network management protocol, the exhaustive configuration process leads to frustrating experiences to most users.

As for the UPnP protocol, the UPnP architecture is very large and complex. More importantly, the drawback of utilizing UPnP protocol to allow configuration of network devices is that, while engaged in files transfer or resources sharing, the files/resources are susceptible to privacy invasion, as other users on the network are capable of accessing the same files. Due to such vulnerabilities, security of UPnP raises concerns for users.

Accordingly, there is a need to provide an easy, and secure way to expedite the process of configuring attributes of multiple network devices.

### SUMMARY OF THE INVENTION

It is therefore an object of the invention to provide a method of configuring a network device, for expediting the configuration of many attributes of the network device and multiple network devices, and minimizing the aforementioned problems associated with the configuration process.

The invention achieves the above-identified object by providing a method of configuring an network device based on an easy configuration protocol, the method including: first, discovering the network device by sending a discovery packet, where the discovery packet includes a port number, and a destination address for broadcasting; then, receiving a response packet sent by the network device if the network device recognizes the discovery packet and if the port number of the network device is the same as indicated by the discovery packet; then, sending a query packet to query management information of the network device by; then, from the network device, receiving a management packet having the management information in response to the query packet; next, sending a setting packet having a plurality of attributes based on the management information to set the network device; and receiving a setting complete packet from the network device in response to the setting packet.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows illustration of a network system.

FIG. 2 shows a flow chart of a method of configuring an network device according to a preferred embodiment of the invention

FIG. 3 shows a format of a packet according based on an easy configuration protocol according to a preferred embodiment of the invention.

### DETAILED DESCRIPTION OF THE INVENTION

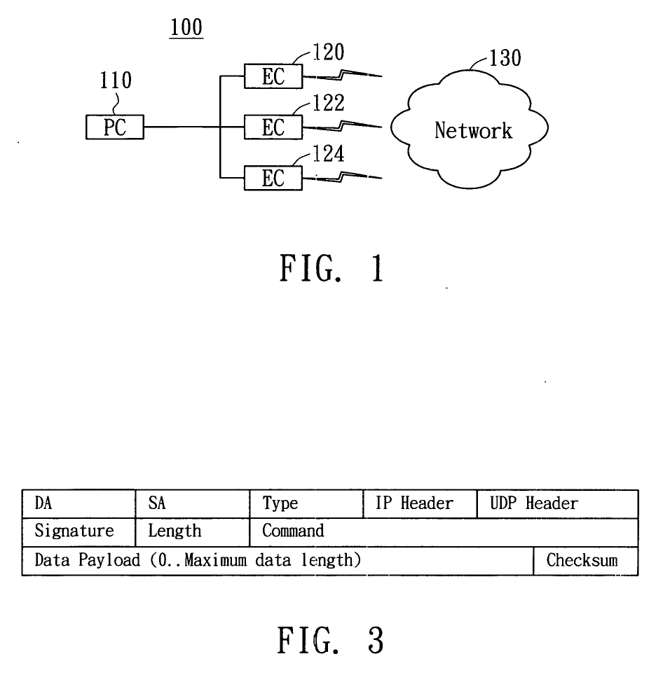

FIG. 1 shows illustration of a network system 100. The network system 100 includes a PC 110, acting as a client device, and a plurality of network devices, such as ethernet converters (ECs) 120, 122 and 124 that are acting as a server device for connecting to the network 130. The network device can be Access Point, Home Gateway, ADSL, VoIP, Internet Access Device, IP setTop Box, and Media Player. When the ECs are first time used, configurations are required to set a plurality of attributes, such as IP address and other functional settings. PC 110 is physically or wirelessly connected to ECs 120, 122, and 124, and is for configuring the attributes of the ECs so that PC 110 and other client devices (not shown) can utilize the services provided by the ECs.

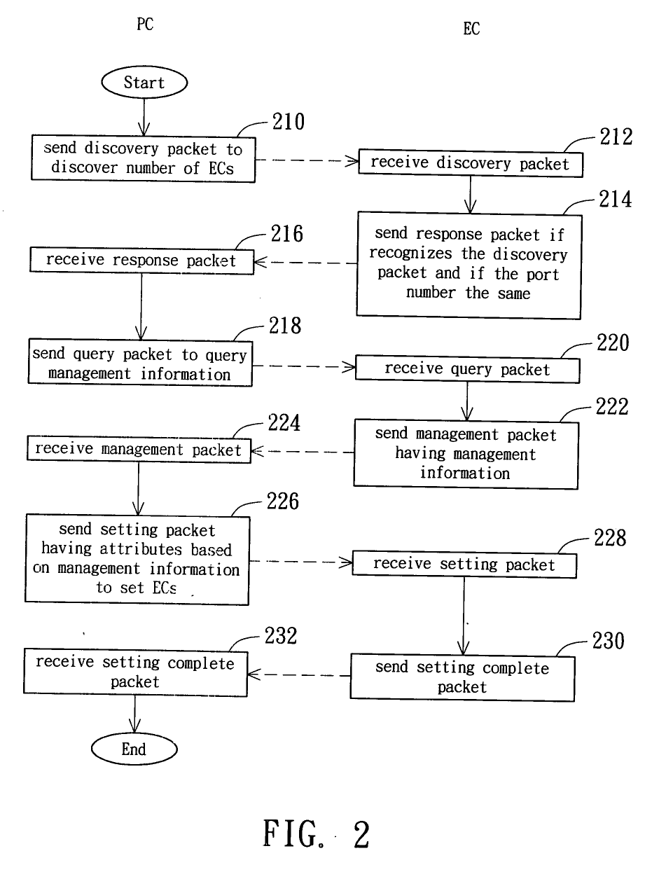

FIG. 2 shows a flow chart of a method of configuring an network device according to a preferred embodiment of the invention. The method utilizes an easy configuration protocol provided by this embodiment such that PC 110 and ECs need not to be in the same IP subnet and that PC 110 can simultaneously configure a plurality ECs. Initially in step 210, PC 110 sends a discovery packet based on the easy configuration protocol to discover the number of ECs present. The discovery packet includes a port number and a destination address for broadcasting.

By broadcasting the discovery packet, all the ECs of interest (EC 120, EC122, and EC124) equipped with the easy configuration protocol will be able to receive and recognize the discovery packet, regardless of whether the ECs and the PC 110 are in the same IP subnet, as shown in step 212. In addition, PC 110 and the ECs need to use the same port number to communicate, and the port number is stored in the discovery packet to inform the ECs. With regards to the broadcast packet, more specifically, the destination address refers to MAC destination address and IP destination address, such that PC 110 does not have to search for an unused IP as a default IP address for the ECs.

After receiving the discovery packet in step 212, ECs 120, 122 and 124 each sends out a response packet to inform PC 110 at step 214. Within a short duration of time, such as five seconds, PC 110 receives the response packets and obtains knowledge of the number of ECs present by the number of received response packets (step 216). Next, PC110 sends a query packet to retrieve management information relating to the ECs (step 218). Then, reacting to the query packet received in step 220, each of the ECs in return sends a query complete packet to PC110 (step 222). Next in step 224, PC110 receives the management packets that include the management information, whereby in step 226 following, PC110 sends a setting packet having a plurality of attributes based on the management information to set the ECs. The attributes of ECs that are settable by PC 110 include the following: Station Name, Network Name (SSID), Operation Mode, (Infrastructure or Adhoc Mode), Channel Number, Country Code (or Domain Name), Encryption Type, Authentication Mode and Key Management, Beacon Level, Fragmentation Threshold, RTS/CTS Threshold, IP Settings (Static IP, DHCP), Administrator Password, Preamble Type (Short, Long), Transmission Power Level, and Antenna Selection.

After receiving the setting packet (step 228), ECs 120, 122 and 124 responsively each sends a setting complete packet to PC 110 to inform of completion (step 230). Then, in step 232, PC110 receives the set complete packets, thereby completing the steps of configuration.

In addition, with regards to the port number, the discovery packet includes a header field that is used for encapsulating the port number with the headers in the header field, so that the PC and ECs can communicate via ports designated by the port number.

Also for all the packets described above, including the discovery packet, the response packet, the query packet, the management packet, the setting packet, and the setting complete packet, each comprises a signature field for recognition of the easy configuration protocol. By being able to recognize the discovery packet, the PC can then initiate transfer to the ECs simultaneously under the same easy configuration protocol.

Additionally, PC 110 can also send a reset packet to reset the ECs, and in response, the ECs will send a reset complete packet to PC 110 after a short duration of time has elapsed. Alternatively, PC 110 can send further additional commands intended to manage the ECs in the form of instruction packets.

In consequence, as illustrated in the preferred embodiment of the invention, based on the easy configuration protocol, the discovery packet, the response packet, the query packet, the management packet, the setting packet, and the setting complete packet can be readily transmitted between PC 110 and ECs 120, 122 and 124.

FIG. 3 shows a format of a packet generated by PC 110 and EC 120, EC122 and EC124 based on the easy configuration protocol. The packet includes the following fields: data address (DA), source address (SA), type, IP header, UDP (User Datagram Protocol) header, signature, length, command, data payload, and checksum. DA field provides information of the destination address of where to send the packets, where as SA field provides information of where the packets are sent. To enable broadcasting, DA bits are set to ff . . . f. Type field provides information of the packet type, while the port number is encapsulated in the UDP or IP header field, or both. Signature field contains a code that represents the easy configuration protocol and the version thereof so as to be recognized by PC 110 and ECs. The length field is the sum of the length of the command and the data payload, which are respectively stored in the command field and the data payload filed. Data payload field should contain 2*n octets. Finally, the checksum field in the packet is to sum the fields of signature, length, command, data payload, and checksum to check for errors, and is calculated in 16-bit basis without carry, and should have a sum that equals 0x0000.

Resultantly, by sending packets that contain pre-determined port numbers, and using the broadcasting method while under the same easy configuration protocol, the embodiment of the invention can save users time by expediting the configuration process, in which users do not have to search for an unused IP address of the ECs in the same subnet as PC 110, and more importantly, users are able to configure multiple ECs simultaneously, making the configuration process more easy and efficient. Moreover, the proposed method of configuring an network device according to the preferred embodiment of the invention has less securities issues than aforementioned conventional methods, since only ECs that are recognizable of the signature can receive the packets sent by the PC.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of configuring a network device based on an easy configuration protocol, the method comprising:
discovering the network device by sending a discovery packet, wherein the discovery packet comprises a port number, and a destination address for broadcasting;
receiving a response packet sent by the network device if the network device recognizes the discovery packet, and if the port number of the network device is the same as indicated by the discovery packet;
querying management information of the network device by sending a query packet;
receiving a management packet having the management information from the network device in response to the query packet;
sending a setting packet having a plurality of attributes based on the management information to set the network device; and
receiving a setting complete packet from the network device in response to the setting packet.

2. The method according to claim 1, wherein the destination address is a MAC address.

3. The method according to claim 1, wherein the destination address is an IP address.

4. The method according to claim 1, wherein the discovery packet comprises a header field, for storing the port number.

5. The method according to claim 1, wherein the discovery packet, the response packet, the query packet, the management packet, the setting packet, and the setting complete packet each comprises a signature field for recognition of the easy configuration protocol.

6. The method according to claim 1 simultaneously configuring a plurality of the network devices.

7. The method according to claim 1 further comprising:
resetting the network device by sending a reset packet; and
receiving a reset complete packet from the network device in response to the reset packet after being reset.
